(19) United States
(12) Patent Application Publication
(10) Pub. No.: US 2024/0372441 A1
(43) Pub. Date: Nov. 7, 2024

(54) Evaporative embedded thermal management of electric motor

(71) Applicant: Georgia Tech Research Corporation, Atlanta, GA (US)

(72) Inventors: Yogendra K. Joshi, Atlanta, GA (US); Joon Woo Kim, Atlanta, GA (US); Ryan Smith, Atlanta, GA (US); Jonathan Goldman, Atlanta, GA (US)

(21) Appl. No.: 18/403,446

(22) PCT Filed: Jul. 21, 2022
(86) PCT No.: PCT/US2022/037826

§ 371 Date: Jan. 3, 2024

Related U.S. Application Data
(60) Provisional application No. 63/224,205, filed on Jul. 21, 2021.

(51) Int. Cl. H02K 9/20; H02K 3/30; H02K 9/193

(52) U.S. Cl. CPC H02K 9/20; H02K 3/30; H02K 9/193; H02K 2209/00

(57) ABSTRACT

A cooling system for an electrical winding (14) includes a winding liner (100) that has at least one wall (102) that defines a plurality of channels (110) that are in communication with the winding (14). A coolant has a liquid state (112) and a gaseous state (114). The coolant passes through the channels (110) so that the coolant is in contact with at least a portion of the electrical winding (14). The coolant has a heat of evaporation such that at least a portion of the coolant evaporates as the coolant absorbs heat from the electrical winding (14). A delivery mechanism (200) delivers the coolant to the channels (110). A heat exchanger (212) cools the coolant after the coolant has passed through the channels (110) to condense the coolant into the liquid state.

### CROSS-REFERENCE TO RELATED APPLICATION(S)

This application claims the benefit of U.S. Provisional Patent Application Ser. No. 63/224,205, filed Jul. 21, 2021, the entirety of which is hereby incorporated herein by reference.

### STATEMENT OF GOVERNMENT SUPPORT

This invention was made with government support under grant number DE-AR0001023, awarded by the Department of Energy. The government has certain rights in the invention.

### BACKGROUND OF THE INVENTION

### 1. Field of the Invention

The present invention relates to electric motors and, more specifically, to a cooling system for an electric motor.

### 2. Description of the Related Art

With transport electrification becoming more commonly used, along with the associated increase in demand for electric motors, different cooling techniques have been developed and applied. The most used colling method is water jacket cooling. Other methods include, direct cooling of rotor, and spray cooling. However, these methods employ single phase cooling in which the coolant is separated by multiple thermal resistances from the primary heat source (copper windings in the stator). Effective cooling of the motor windings directly affects the performance and the efficiency of the motor.

Stringent greenhouse gas emission standards have accelerated the need for electrification of ground and air transportation. Since electric machines are one of the core components of the electric drivetrain, improvement of their performance is a key enabler of better performance metrics of electric drivetrains. These performance metrics include higher power and torque density, better fuel economy (and the associated lower cost per mile), and overall drivetrain efficiency. Permanent magnet synchronous motors (PMSM) are commonly used in traction powertrains because of their superior performance on these metrics. However, high heat generation in PMSMs as a consequence of electro-magnetic losses especially at high power density limits motor efficiency and longevity by ultimate aging of the winding wire insulation and premature demagnetization of the magnets. Therefore, enhanced cooling technology is important in increasing motor power and torque density by pushing up the current density, while keeping peak winding temperature below the winding insulation temperature threshold without compromising efficiency.

For low power density electric machines, typically air cooling is used, whereas indirect liquid cooling is used for high power density electric motors. Typically, in automotive and industrial machines, closed loop liquid cooling via an external cooling jacket is utilized. However, jacket cooling (JC) technology often suffers from poor heat extraction from the winding to the external coolant because of the multiple thermal resistances between the winding and the coolant.

The thermal resistance between the winding and the coolant can be reduced by placing the cooling channel directly in the stator lamination. However, cooling channels in stator lamination can alter the magnetic flux path by imposing extra reluctances. By realizing these limitations of the JC and direct stator cooling, one system employed a water cooled direct winding heat exchanger (DWHX) concept to extract heat directly from the winding. Water cooled DWHX reduces thermal resistances between the windings and the coolant, and hence higher current density can be achieved while operating within the insulation's thermal limit.

Recent improvements in 3D printing technology enable fabrication of complex DWHX geometry along with internal flow channels to further improve the efficacy of DWHX. However, DWHX reduces cooper fill factor by occupying slot area, which eventually results in high copper loss. Also, water cooled DWHX can be used only in concentrated wound machines.

Additionally, proper sealing needs to be ensured for safe operation of water cooled DWHX systems. Water can be replaced by an oil/dielectric coolant to minimize the water leakage risk, but only at the expense of poor thermal and hydraulic performance. One system replaced the centermost conductor bunch in a standard Litz wire bundle of a tooth-coil axial-flux permanent-magnet motor by axial stainless steel cooling channel. Although use of an axial cooling channel significantly reduces the machine temperature, the fabrication of a Litz wire bundle with axial cooling channel adds complexity to the system. One system uses an axial cooling channel in the bottom of the stator slot of a switched reluctance motor and also an applied enhanced polymer composite as potting material to reduce the thermal resistance between the winding and the cooling channel. However, potting material thermal resistance can be significant.

In conventional external jacket cooled motors, end-windings are commonly identified as motor hot-spots because of the limited heat dissipation through the air gap between the end-winding and the housing where cooling ducts are located. One system places a liquid-carrying plastic pipe in the end-windings to reduce the thermal resistance between the end-winding and the coolant. However, this end-winding cooling technique often suffers from increased end-winding length, resulting in increased copper loss and contact resistance between the end-winding and the coolant carrying pipe. One system applies thermally conductive potting material (3.5 W/mK) in the end-space to provide a direct conductive heat transfer path between the end-winding and the external cooling channel. However, the application of potting material in large size traction motors is challenging and the additional weight of the potting material results in a lower specific output power and torque.

A latent heat driven two-phase cooling technique employing a heat pipe has also been used for high power density electric motor thermal management. With such a technique, an evaporator section of the heat pipe is placed directly in the stator slot, while a condenser section is axially extended beyond the stator up to a cooling chamber/air heat exchanger. Lower copper fill factor and risk of heat pipe leakage are the major drawbacks of these cooling techniques. The evaporator section of the heat pipe can also be placed inside the rotor/shaft, but this concept suffers from high risk of heat pipe damage, especially at high rotational speed.

Oil spray cooling is another two-phase cooling technique used for the end-winding cooling. Although it has a high heat transfer coefficient, a uniform end-winding temperature can be achieved by employing spray cooling. However, a high pumping power requirement offsets the thermal benefits of the spray cooling.

Close placement of the cooling medium to the winding is aviable thermal management techniques. However, low copper fill factor, high losses, high winding-liner and liner-lamination contact resistances, high manufacturing complexity, and limited application in concentrated wound machines often outweigh the thermal benefits of single-phase DWHX.

Therefore, there is a need for a cooling system that provides high copper fill factor, low losses, low winding-liner and liner-lamination contact resistances, low manufacturing complexity with the thermal benefits of DWHX.

### SUMMARY OF THE INVENTION

The disadvantages of the prior art are overcome by the present invention which, in one aspect, is a cooling system for an electrical winding that includes a winding liner that has at least one wall that defines a plurality of channels that are in communication with the winding. A coolant has a liquid state and a gaseous state. The coolant passes through the channels so that the coolant is in contact with at least a portion of the electrical winding. The coolant has a heat of evaporation such that at least a portion of the coolant evaporates as the coolant absorbs heat from the electrical winding. A delivery mechanism delivers the coolant to the channels. A heat exchanger cools the coolant after the coolant has passed through the channels so as to condense the coolant into the liquid state.

In another aspect, the invention is an electric motor system that includes a shaft and a cylindrical rotor disposed about the shaft and complementary in shape to the inner cylindrical passage. The rotor includes a plurality of permanent magnets disposed about the rotor. A stator defines an inner cylindrical passage that is coaxial with and disposed around the cylindrical rotor. The stator includes a plurality of windings embedded in and evenly radially disposed in the stator. Each winding has an inner end that abuts the inner cylindrical passage. Each of plurality of winding liners is disposed around a different one of the windings. Each of the plurality of winding liners includes an inner surface that defines a plurality of micro-channels that open to the windings. A coolant has a liquid state and a gaseous state. The coolant flows through the micro-channels. A portion of the coolant changes from the liquid state to the gaseous state as the coolant absorbs heat from the windings. A heat exchanger cools the coolant after it has passed through the micro-channels until substantially all of the coolant has condensed into the liquid state.

In yet another aspect, the invention is a method of cooling a winding in an electric motor in which a liner is placed about the winding. The liner has a surface defining a plurality of micro-channels that open to the winding. A coolant is passed through the micro-channels to absorb heat from the winding. The coolant has a liquid state and a gaseous state. A portion of the coolant changes from the liquid state to the gaseous state as the coolant absorbs heat from the winding. Heat is removed from the coolant after the coolant has passed through the micro-channels so as to condense coolant from the gaseous state to the liquid state.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a permanent magnet synchronous motor employing an evaporative cooling system.

FIG. 2 is a schematic diagram of a section of a stator portion of an electric motor employing evaporative cooling liner jackets around the windings.

FIG. 3 is a schematic diagram showing a detail of coolant channels in a cooling liner jacket.

FIG. 4 is a schematic diagram showing a cooling liner jacket and a winding.

FIG. 5 is a block diagram of an electric motor system employing a cooling liner jacket system.

FIG. 6 is a schematic diagram showing one method of making a cooling liner jacket.

FIG. 7A-7D are schematic diagrams showing one method of making a microchannel or micropillar array used in a cooling liner jacket.

FIG. 7E-7F are photographs of a micropillar array and a mold for making a micropillar array.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

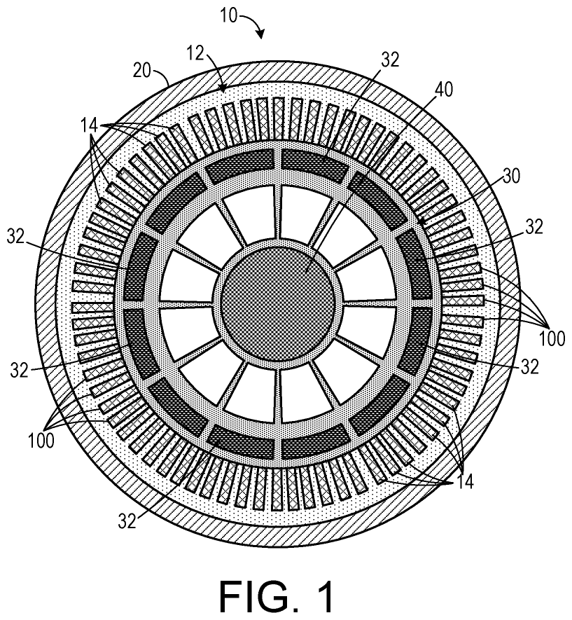

As shown in FIG. 1, one representative embodiment of a permanent magnet synchronous motor 10 employing an evaporative cooling (EC) system according to the present invention includes casing 10 that houses a stator 12. Embedded in the stator 12 is a plurality of electrical windings 14 that extend radially outwardly from an inner cylindrical surface of the stator 12 that defines a cylindrical passage in the stator 12. Each winding 14 has an inner end that abuts the inner cylindrical passage. Each electrical winding is at least partially enveloped in a winding liner 100 that is configured to deliver an evaporative coolant to the corresponding winding 14. The coolant flows between the winding and the liner so as to evaporate directly on an outer surface of the winding by absorbing heat therefrom. A cylindrical rotor 30 is disposed in the cylindrical passage defined by the stator 12. A plurality of permanent magnets 32 are embedded about the outer surface of the rotor 30. A shaft 40 is coaxial with the rotor 30 and attached thereto. When an electric current flows through the windings 14, an induced magnetic field interacts with the permanent magnets 32 to generate rotational force that is applied to the rotor 30 causing the shaft 40 to rotate. Also, application of a current to the windings 14 results in the generation of heat that is removed by the evaporative coolant flowing through the winding liner 100.

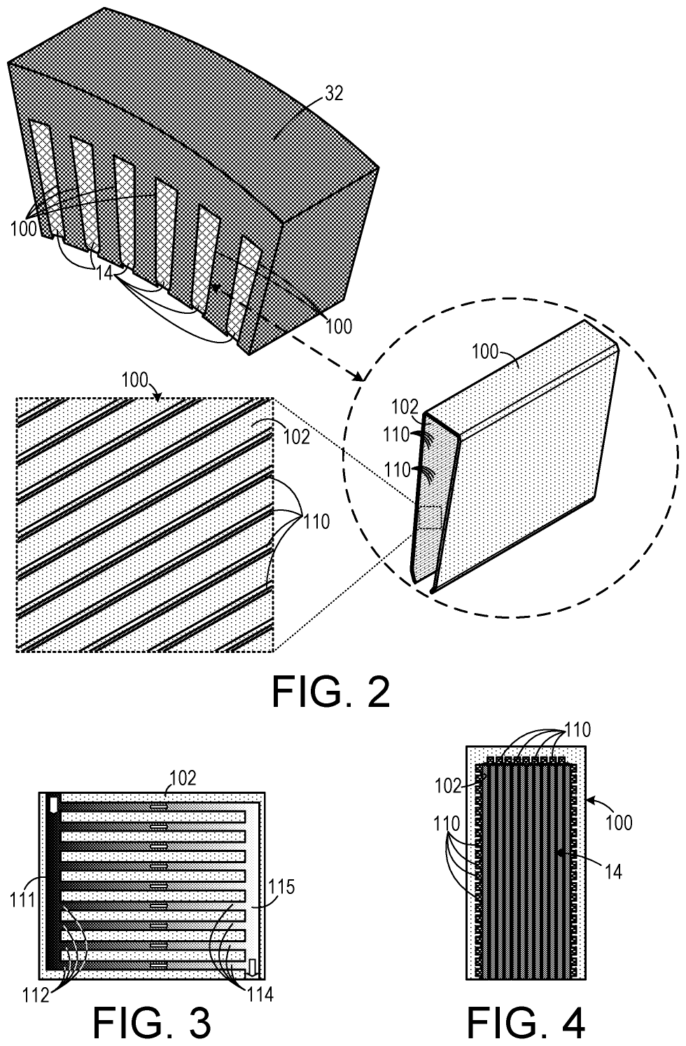

As shown in FIGS. 2, 3 and 4, the winding liner 100, which can include PDMS (or any other material suitable to provide sufficient electric breakdown strength, resistance to tearing and that do not degrade under conditions of temperature, vibration and electric field, depending on the specific embodiment and operating environment) and which is about 2.0 mm to 3.0 mm thick in one experimental embodiment, has an inner wall 102 that is placed against the winding 14. The wall 102 defines a plurality of channels 110, such as microchannels, into which a dielectric coolant (such as a perfluorinated liquid coolant, such as FC-84 with a saturation temperature of 80° C.) flows. The coolant has a liquid state 112 and evaporates into a gaseous state 114 as it absorbs heat from the winding 14. A delivery mechanism delivers the liquid coolant 112 to the channels 110 via an input manifold 111 and at least partially evaporated coolant 114 flows out of the channels 110 via an output manifold 115. The manifolds 111 and 115 may be in fluid communication with winding endcaps that interface with a heat exchanging system, as disclosed below. In one embodiment, the micro-channels 110 have dimensions that cause the coolant 112 to wick through a portion of the micro-channels 110 through capillary action. The channels 110 may be disposed horizontally, vertically or even diagonally relative to the windings 14, depending on the specific embodiment. The coolant flows between the active-winding and liner and evaporates directly from the outer surface of the active-winding by absorbing heat from the winding.

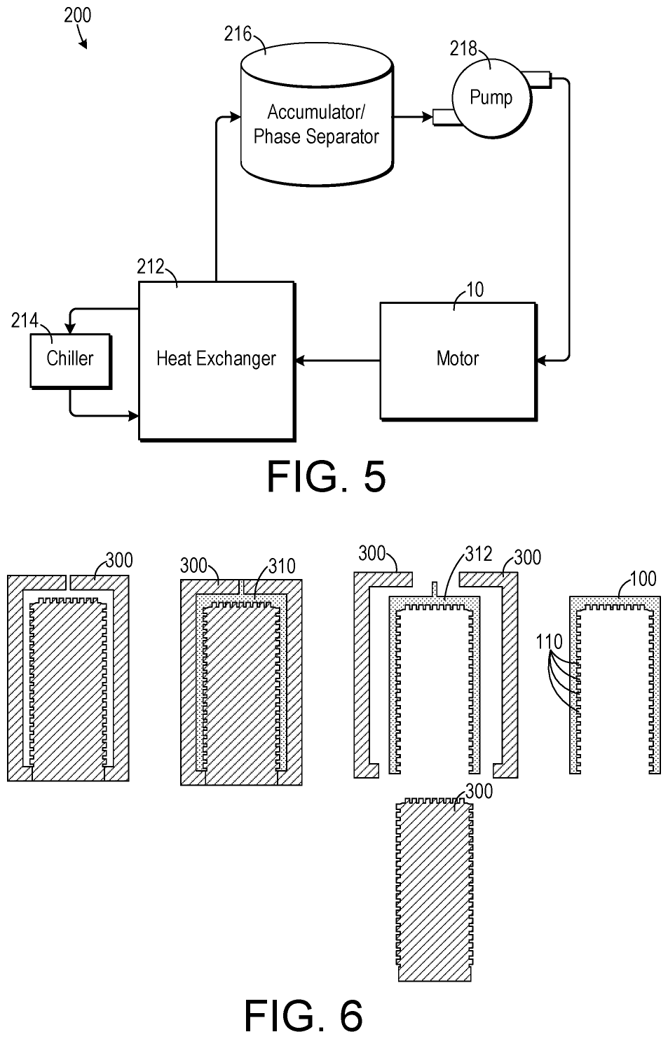

As shown in FIG. 5, one embodiment of a cooling system 200 that is used to cool a motor 10 includes a pump 218 that pumps liquid coolant into the motor 10 for delivery to the input manifold 110. At least partially evaporated coolant that has flowed into the output manifold 115 is delivered to a heat exchanger 212 that can employ a chiller 214 to condense the gaseous state coolant into a liquid state. The now mostly liquid coolant then passes into an accumulator/phase separator 216 that stores the coolant and that separates remaining gaseous state coolant from the liquid state coolant. The liquid state coolant is then moved by the pump 218 for another cooling cycle into winding liners 100 in the motor 10.

As shown in FIG. 6, in one method of making a winding liner 100, a mold 300 of the liner with the micro-channels is generated using known techniques, such as lithography. The liner material 310, such as PDMS, is injected into the mold 300 and the liner material 310 is cooled and/or cured. The mold 300 is removed, leaving a cast 312. Any sprues are removed from the cast 312 and any other finishing is done, leaving the liner 100 with the micro-channels 110. In certain embodiments, other methods of generating the winding liner 100 can include: nano-imprint lithography, diamond tooling creating via nickel electro form for stamping, embossing, laser drilling; chemical etching; employing wire EDM; and combinations thereof.

One experimental embodiment of the invention includes a design of an electric traction drive (electric motor) cooling system. This embodiment employs a method of windings-cooling that uses wick-assisted two-phase flow. The embodiment uses a dielectric coolant in direct contact with the heat source, which reduces several thermal resistances.

Dielectric coolant enters the motor, which is vacuumed sealed to form a closed system. The coolant is delivered to each of the slots of the stator through a combination of capillary pumping by wicking and mechanical pumping into individual slots. The coolant is in direct contact with the copper windings within each of the slots in the stator via the channels in the winding liners. It removes the heat dissipated by the copper windings and in the process evaporates, forming a mixture of liquid phase coolant and vapor phase coolant. The two-phases of the coolant is collected from the opposite side of the stator and is sent to the heat exchanger where it is liquefied and then re-enters the stator, repeating its cooling process. This design of the motor with two-phase cooling using embedded wicking in the channels improves the power density, as well as the efficiency of the motor.

The experimental embodiment includes a flow assisted thin film EC technique confined between the slot liner and active-winding of electric motor. EC in the interfacial region between the liner and active-winding can be utilized to extract heat directly from the winding without altering the winding configurations (i.e., the copper fill factor). Two-way coupled EM-computational fluid dynamics (CFD)/heat transfer (HT) simulations have demonstrated the effectiveness of the EC over conventional JC for a BMW i3 motor.

In high power density electric motors, heat losses are generated in the windings in the form of resistive heating. In JC, heat needs to flow from the winding to the external coolant via stator tooth, back iron, and finally the housing. Additionally, winding-liner, liner-tooth/back iron, and stator lamination-housing contact resistances increase the overall thermal resistance between the winding and the coolant. This long resistance chain can create hot spots inside the winding.

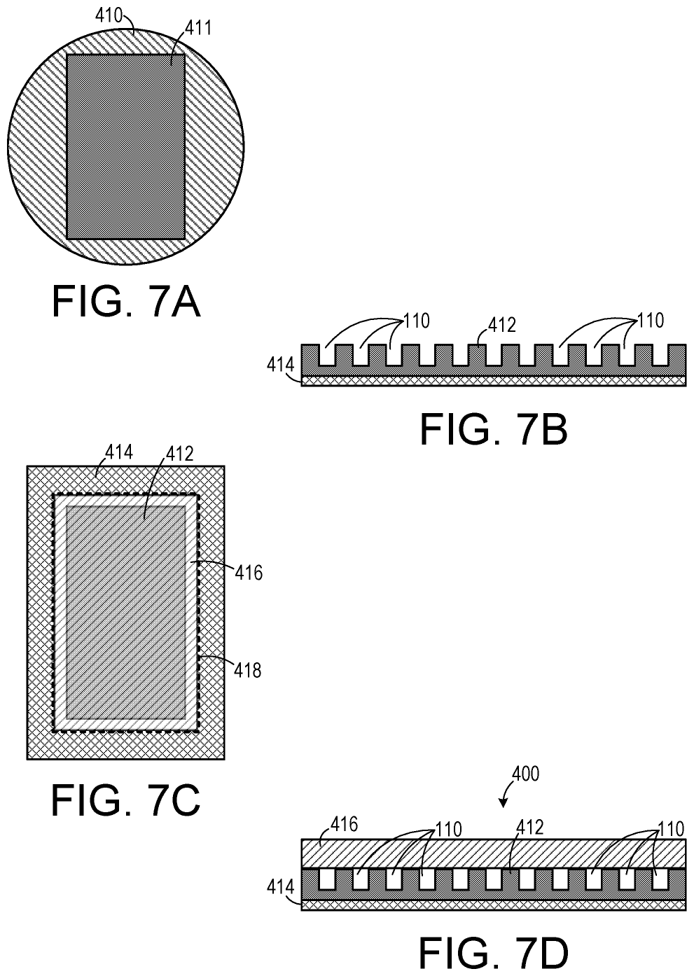

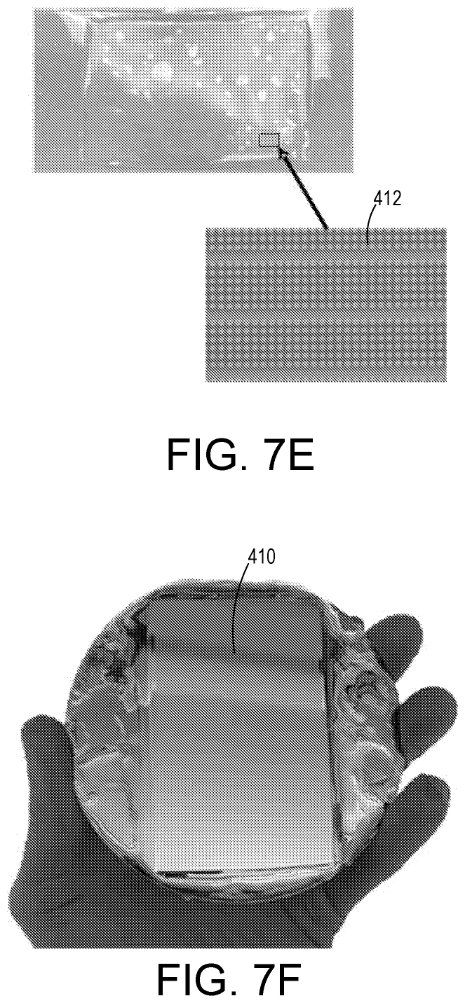

While one embodiment discussed above employs microchannels, the winding liner 100 can also employ an array of spaced apart micropillars. As shown in FIGS. 7A-7F, in one experimental method of making a micropillar array structure 400, a master mold 410 is generated using a deep reactive ion etch so as to include a negative copy of the wick structure 411. A silicone elastomer (such as PDMS) is poured onto the master mold 410, then degassed and cured in an oven. The resulting wick structure 412 is peeled away from the master mold 410 and adhered to a plastic substrate 414 using an adhesive 418. To protect the wick structure 412 from being fouled due to motor resin impregnation, a protective layer of material can be adhered to the surface 416. The polyamide protective film 412 prevents motor resin from entering the wick structure 412. A photograph of such a wick structure 412 is shown in FIG. 7E and a photograph of a master mold 410 is shown in FIG. 7F.

In one embodiment, the micro-wicking structure can be printed, stamped or embossed on the surface of flexible polymers such as polydimethylsiloxane (PDMS) and used as liner material in an electric motor. A wick enhanced PDMS liner can be inserted in the slots in such a way that wick micro-structures wrap the active windings. Hence, a channel structure can be created between the active-windings and the PDMS liners. Utilizing the capillary effect of the wick micro-structure, coolant in the form of a liquid thin film can be sucked and flowed axially through the channel structure between the active-winding and wick enhanced PDMS liner. Thin film evaporation confined between the liner and active-winding (i.e., evaporation directly outside of the active-winding) can significantly reduce the thermal resistance between the winding and the coolant by eliminating the winding-liner contact resistance, and hence can enhance the heat extraction from the winding. EC can also take advantage of high latent heat of vaporization, and heat transfer (contact) area between the winding and liner. Another advantage of the EC system is that it can be employed irrespective of different winding configurations. Compared to the JC and DWHX, latent heat driven EC can significantly reduce the pumping power requirement by lowering the coolant flow rates and utilizing capillary action of the wick.

To implement EC in a traction motor, a stator sleeve may be used to prevent any coolant leaking from the stator slots to the rotor. Additionally, some sort of coolant delivery arrangement, such as using a coolant reservoirs and end caps, may be used.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112 (f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A cooling system for an electrical winding, comprising:
(a) a winding liner that includes at least one wall that defines a plurality of channels that are in communication with the winding;
(b) a coolant, having a liquid state and a gaseous state, that passes through the channels so that the coolant is in contact with at least a portion of the electrical winding, the coolant having a heat of evaporation such that at least a portion of the coolant evaporates as the coolant absorbs heat from the electrical winding;
(c) a delivery mechanism that delivers the coolant to the channels; and
(d) a heat exchanger that cools the coolant after the coolant has passed through the channels so as to condense the coolant into the liquid state.

2. The cooling system of claim 1, wherein the winding liner comprises PDMS.

3. The cooling system of claim 1, wherein the channels comprise micro-channels.

4. The cooling system of claim 3, wherein the micro-channels have dimensions that cause the coolant to wick through a portion of the micro-channels through capillary action.

5. The cooling system of claim 1, wherein the delivery system includes a pump.

6. The cooling system of claim 5, wherein the delivery system includes an accumulator and a phase separator that separates liquid coolant from gaseous coolant and delivers liquid coolant to the pump.

7. The cooling system of claim 1, wherein the coolant comprises a perfluorinated liquid coolant.

8. The cooling system of claim 1, wherein the coolant flows between the winding and the liner so as to evaporate directly on an outer surface of the winding by absorbing heat therefrom.

9. An electric motor system, comprising:
(a) a shaft;
(b) a stator defining an inner cylindrical passage that is coaxial with and disposed around the cylindrical rotor, the stator including a plurality of windings embedded in and evenly radially disposed in the stator, each winding having an inner end that abuts the inner cylindrical passage;
(c) a cylindrical rotor disposed about the shaft and complementary in shape to the inner cylindrical passage, the rotor including a plurality of permanent magnets disposed about the rotor.
(d) a plurality of winding liners, each of which is disposed around a different one of the windings, each of the plurality of winding liners including an inner surface that defines a plurality of micro-channels that open to the windings;
(e) a coolant having a liquid state and a gaseous state that flows through the micro-channels, a portion of which changes from the liquid state to the gaseous state as the coolant absorbs heat from the windings;
(f) a heat exchanger that cools the coolant after it has passed through the micro-channels until substantially all of the coolant has condensed into the liquid state.

10. The electric motor system of claim 9, wherein the winding liners comprise PDMS.

11. The electric motor system of claim 9, wherein the micro-channels have dimensions that cause the coolant to wick through a portion of the micro-channels through capillary action.

12. The electric motor system of claim 9, further comprising a pump that moves coolant from the heat exchanger to the winding liners.

13. The electric motor system of claim 12, further comprising an accumulator and a phase separator that separates liquid coolant from gaseous coolant and delivers liquid coolant to the pump.

14. The electric motor system of claim 9, wherein the coolant comprises a perfluorinated liquid coolant.

15. The electric motor system of claim 9, wherein the coolant flows between the windings and the liners so as to evaporate directly on an outer surface of the windings by absorbing heat therefrom.

16. The electric motor system of claim 10, wherein the PDMS has been cast in a mold that defines shapes that are complementary to the micro-channels.

17. A method of cooling a winding in an electric motor, comprising the steps of:
(a) placing a liner about the winding, the liner having a surface defining a plurality of micro-channels that open to the winding;
(b) passing a coolant through the micro-channels to absorb heat from the winding, the coolant having a liquid state and a gaseous state, so that a portion of the coolant changes from the liquid state to the gaseous state as the coolant absorbs heat from the winding; and
(c) removing heat from the coolant after the coolant has passed through the micro-channels so as to condense coolant from the gaseous state to the liquid state.

18. The method of claim 17, further comprising the step of fabricating the liner by generating a mold of the liner with the micro-channels using lithography and then casting PDMS into the mold.

19. The method of claim 18, further comprising the step of fabricating the micro-channels so as to have dimensions that cause the coolant to wick through a portion of the micro-channels through capillary action.

20. The method of claim 17, further comprising the step of fabricating the liner by a method selected from a list consisting of:
nano-imprint lithography, diamond tooling creating via nickel electro form for stamping, embossing, laser drilling; chemical etching; employing wire EDM; and combinations thereof.

21. The method of claim 17, wherein the coolant comprises a perfluorinated liquid coolant.
